(19) United States
(12) Patent Application Publication
(10) Pub. No.: US 2008/0031283 A1
(43) Pub. Date: Feb. 7, 2008

(54) Time synchronization for network aware devices

(76) Inventors: Martin Curran-Gray, Dunfermline (GB); Jeff Burch, Palo Alto, CA (US); Slawomir L. Ilnickl, Los Altos Hills, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/499,993

(22) Filed: Aug. 7, 2006

(51) Int. Cl. H04J 3/06

(52) U.S. Cl. 370/503; 370/516

(57) ABSTRACT

Time synchronization for network devices with reduced processing requirements for slaves. A master sends a time request message to the slave, including the time T1 at which it sent the message. The slave receives the time request message and records the time T2 at which it received the message. The slave sends a time response message to the master that includes the time T2, the time T1 at which the time request message was sent, and the time T3 at which it sent the time response message. The master receives the time response message and records the time T4 at which it was received. The master estimates the one-way delay from the times T1, T2, T3 and T4. The master determines whether the slave's clock is synchronized with the master's clock and if not, sends a sync message that contains information usable by the slave to sync its clock.

### BACKGROUND

Most computers and programmable circuits include clocks that send timing pulses to various components and synchronize their operation. Without this synchronization, the components may not work in a coordinated fashion, which can cause the computer or programmable circuit to operate incorrectly or to even crash.

Distributed systems typically include computers or other programmable circuits that form nodes, which are connected in a network and exchange data or control signals. In these systems, a master node initiates communication of the data or control signal and a slave node responds to the signal. Many such distributed systems also require clock or time synchronization between the master and slave nodes to properly process the data and control signals. Again, failure to synchronize the nodes can result in one or more of the nodes operating incorrectly and potentially crashing.

There are standards for time synchronization between nodes in a network. These standards enable nodes that are manufactured by different companies to operate in a synchronized manner. An example of such a standard is the IEEE 1588 Standard for a Precision Clock Synchronization Protocol for Networked Measurement and Control Systems” (hereinafter the IEEE 1588 Standard). In typical implementations of the IEEE 1588 Standard, each slave requires sufficient processing capability to synchronize with its master. This extra processing required for synchronization is expensive and consumes processing power that can be used for performing other tasks.

### SUMMARY

In general terms, this patent is directed to time synchronization for network devices.

One aspect is a method of synchronizing a clock of one device with a clock on another device. The method comprises (a) sending, by a first device, a request for the local time at a second device; (b) recording a time at which the request was sent; (c) receiving a response from the second device, the response including a time at which the second device received the request; (d) storing a time at which the first device received the response; and (e) determining a one-way delay using the time at which the request was sent by the first device, the time at which the second device received the request, a time at which the second device sent the response, and the time at which the first device received the response.

Another aspect is a synchronization system for use in a first device. The system comprises a clock; a timestamp latch coupled to the clock; a time packet recognizer coupled to the timestamp latch; and a packet interface coupled to the time packet recognizer. A computation engine is coupled to the timestamp latch, the clock, and the packet interface. The computation engine is programmed to send a request for the local time at a second device, record a time at which the request was sent, receive from the second device a response including a time at which the second device received the request, store a time at which the first device received the response, and determine a one-way delay using the time at which the request was sent by the first device, the time at which the second device received the request, a time at which the second device sent the response, and the time at which the first device received the response.

Yet another aspect is an apparatus for synchronizing a clock of one device with a clock on another device. The apparatus comprises means for sending, by a first device, a request for the local time at a second device; means for recording a time at which the request was sent; means for receiving a response from the second device, the response including a time at which the second device received the request; means for receiving a time at which the response was sent; means for storing a time at which the first device received the response; and means for determining a one-way delay using the time at which the request was sent by the first device, the time at which the second device received the request, the time at which the second device sent the response, and the time at which the first device received the response.

### BRIEF DESCRIPTION OF THE DRAWINGS

Non-limiting and non-exhaustive embodiments are described with reference to the following figures.

FIG. 1 is a diagram representing a distributed system that includes a master and slaves configured to perform a synchronization process in accordance with an embodiment.

FIG. 2 is a diagram illustrating the timing of messages sent and received in a synchronization process in accordance with an embodiment.

FIG. 3 is a block diagram representing an implementation of a master as depicted in FIG. 1, in accordance with an embodiment.

FIG. 4 is a block diagram representing an implementation of a slave as depicted in FIG. 1, in accordance with an embodiment.

FIG. 5 is a flow diagram representing operational flow of a master in synchronizing a slave, in accordance with an embodiment.

### DETAILED DESCRIPTION

Various embodiments will be described in detail with reference to the accompanying drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many embodiments. Alternative embodiments may be implemented in many different forms other than the exemplary embodiments described herein, and thus the claims attached hereto should not be construed as limited to the embodiments set forth herein. Rather, the disclosed embodiments are provided so that this disclosure will be thorough and complete.

Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

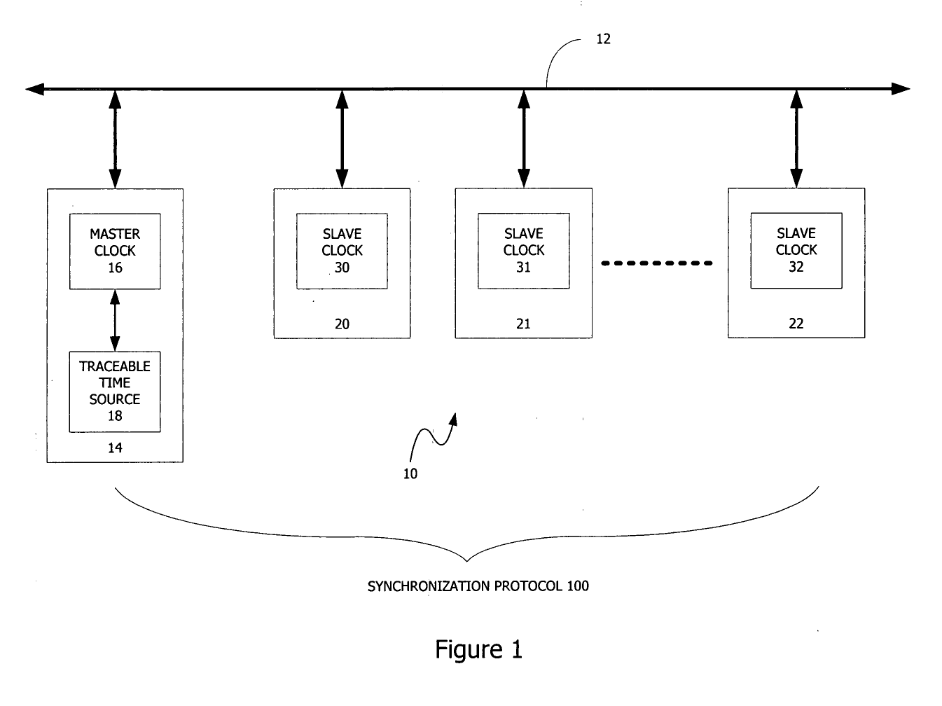

FIG. 1 illustrates distributed system 10 that includes a master and slaves configured to perform a synchronization process via a communications link 12, in accordance with an embodiment. In this embodiment, the system 10 includes a master node 14 that distributes traceable time values to a set of slave nodes 20-22 via the communications link 12. The master node 14 includes a master clock 16 and a traceable time source 18 in this particular embodiment. The slave nodes 20-22 each include a slave clock, indicated as slave clocks 30-32 in FIG. 1.

In this embodiment, the traceable time source 18 of the master node 14 generates traceable time values. A traceable time value may be defined as a time value which is derived from a standard time such as UTC time which was formerly known as Greenwich Mean Time (GMT). The master clock 16 includes mechanisms that synchronize a master time value held in the master clock 16 to the traceable time values obtained from the traceable time source 18.

The master clock 16 and the slave clocks 30-32 are synchronized in this embodiment according to a synchronization protocol 100. According to this embodiment of the synchronization protocol 100, the master node 14 and the slave nodes 20-22 exchange packets via the communication link 12 so that the slave clocks 30-32 synchronize to the master time value held in the master clock 16. As a consequence, traceable time values are accurately distributed to the slave nodes 20-22 using the synchronization protocol 100 because the master time value in the master clock 16 is synchronized to the traceable time values from the traceable time source 18. In some alternative embodiments, the traceable time source 18 is omitted.

In one embodiment, mechanisms implemented in the slave clocks 30-32 to adjust their times are those described in U.S. Pat. No. 5,566,180. For example, in one embodiment each of the slave clocks 30-32 may include circuitry for adjusting its respective locally stored time value based upon computations by the master node 14 and included in messages sent by the master node 14 over the communication link 12. The adjustment of a locally stored time value is accomplished in this exemplary embodiment by implementing a local clock in each slave clock 30-32 as a counter driven by an oscillator with sufficient stability. The least significant few bits of the counter are implemented as an adder so that the increment on oscillator periods are occasionally increased or decreased to effectively speed up or slow down the local clock in accordance with the results of the computation.

In one embodiment, the traceable time source 18 is a global positioning system (GPS) receiver. In other embodiments, other types of traceable time sources are used including radio broadcast time sources such as WWV or atomic clocks.

The master node 14 and the slave nodes 20-22 are implemented as any suitable type of node in the system 10. For example, in some embodiments any one or more of the master node 14 and the slave nodes 20-22 are implemented as one or more of the following: a sensor node, an actuator node, an application controller node, or a combination of these in a distributed control system. In some embodiments, any one or more of the master node 14 and the nodes 20-22 may be a computer system such as a personal computer.

According to various embodiments, the communication link 12 is implemented with one or more of a variety of communication mechanisms. In one embodiment, the communication link 12 is an Ethernet communication network. In another embodiment, the communication link 12 is a LonTalk field-level control bus which is specialized for the process control environment. In other embodiments, the communication link 12 is implemented with time division multiple access (TDMA). In still other embodiments, communication link 12 is implemented as a token ring protocol. In other embodiments, the communication link 12 is implemented with one or more of a variety of communication mechanisms.

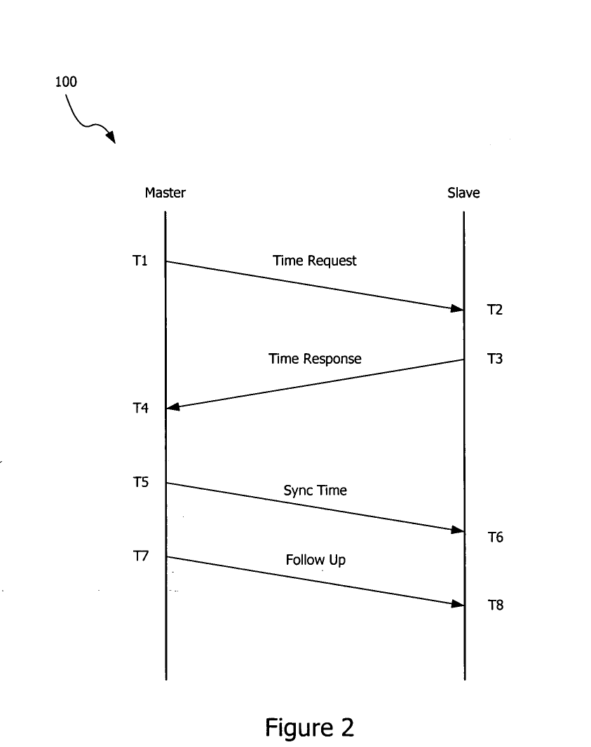

FIG. 2 illustrates the timing of messages sent and received in the synchronization protocol 100 in accordance with an embodiment. In this embodiment, a master node sends a time request message to the slave node, with the master node including in the time request message the time T1 (master's time domain) at which it sent the time request message. Alternatively, the time request message may include a time T0 (master's time domain) that is deterministically related to the time T1 at which the time request message was sent.

The slave node receives the time request message and in response, records the time T2 (slave node's time domain) at which it received the time request message.

The slave node then sends a time response message to the master node that includes the time T2 and the time T1 at which the time request message was sent (obtained from the time request message). It should be noted here that if the value of T1 could not be obtained precisely when the request message is sent then the master node has to only remember the time this message left the master node. In addition, the slave node also includes the time T3 at which the slave node sent the time response message (alternatively, the time T3 is included in a follow-up message to the master node).

The master node receives the time response message from the slave node and records the time T4 (master node's time domain) at which it was received. The master node then estimates the one-way delay from the times T1, T2, T3 and T4. In this exemplary embodiment, the one-way delay is then estimated using equation (1):

dT=0.5[(T4−T3)+(T2−T1)] (1)

where dT is the one-way delay, T4 is the time (master node's time domain) at which master node received the time response message from the slave node, T3 is the time (slave node's domain) at which the slave node sent the time response message, T2 is the time (slave node's domain) at which the slave node received the time request message from the master node, and T1 is the time (master node's domain) at which the master node sent the time request message. This estimation assumes that the delay from master node-to-slave node is the same as the delay from slave node-to-master node and that the difference between the master node's time and slave node's time is the same for both the sync message and the delay request message.

In some embodiments, the master node and slave node repeat this process multiple times so that the master can apply averaging or other statistical techniques to more accurately estimate the one-way delay.

The master node then determines whether the slave node's clock is synchronized with the master node's clock and if not, sends a sync message at time T5 that contains information usable by the slave node to sync its clock with the master node's clock. For example, in one embodiment, the master node determines a clock adjustment interval taking into account the rate at which the master node sends time request messages to this particular slave node. That is, the adjustment interval forms part of a control loop with the slave clock, so the adjustment interval must be determined so that the synchronization process is stable and will converge. In an alternative embodiment, the master sends a message with the time (that takes into account the one-way delay) that the slave node is to set its clock to.

As can be appreciated from FIG. 2, most of the calculations are performed in by the master node. Therefore, the slave node can be implemented with reduced processing capability (or avoiding allocating significant processing capability to the synchronization process) and still perform the synchronization process.

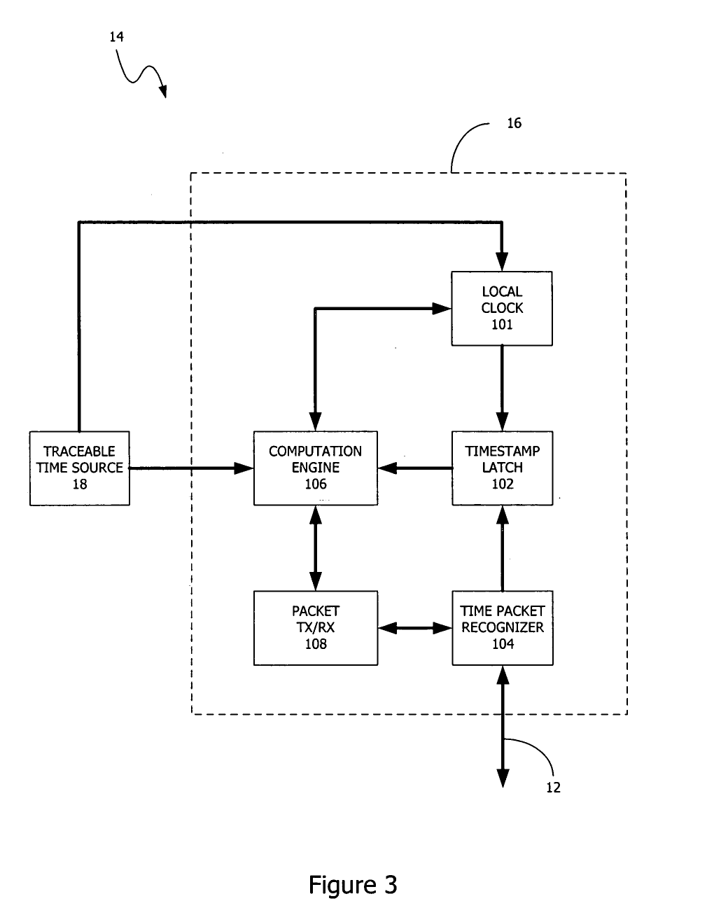

FIG. 3 illustrates an implementation of the master node 14 (FIG. 1), in accordance with an embodiment. In this embodiment, the master node 14 includes in addition to the traceable time source 18, a local clock 101, a timestamp latch 102, a time packet recognizer 104, a computation engine 106 and a packet transmit/receive interface 108. The traceable time source 18 provides traceable time to the local clock 101, which adjusts its time so as to be synchronized with the traceable time source 18.

For example, in one embodiment, the traceable time source 18 generates an updated traceable time value and a series of pulses which in one embodiment occur once per second. The pulses continuously cause the time-stamp latch 102 to latch time values from the local clock 101. The computation engine 106 compares the updated traceable time value to the time values from the time-stamp latch 102 and issues a set of clock adjustment signals that cause the local clock 101 to move toward and eventually match the updated traceable time value.

In one implementation, the computation engine 106 issues the clock adjustment signals to cause the local clock 101 to either speed up, slow down, maintain rate, or reload with a new time value. In one embodiment, the local clock 101 is implemented as a counter driven by an oscillator with an adder that adds either value of A, B or C (e.g., 9, 10 or 11) to the counter during each period of the oscillator. If the time value held in the time-stamp latch 102 is less than the updated traceable time value then the computation engine 106 issues the clock adjustment signals to cause a value of C to be added to the counter of the local clock 101. If the time value held in the time-stamp latch 102 equals the updated traceable time value then the computation engine 106 issues the clock adjustment signals to cause a value of B to be added to the counter of the local clock 101. If the time value held in the time-stamp latch 102 is greater than the updated traceable time value then the computation engine 106 issues the clock adjustment signals to cause a value of A to be added to the counter of the local clock 101. If the difference between the time value held in the time-stamp latch 102 and the updated traceable time value is greater than a predetermined value then the computation engine 106 uses the clock adjustment signal to reload the local clock 101.

In another implementation, the computation engine 106 adjusts the local clock by adding an extra tick after some number of clock ticks when the local clock is too slow, or by just skipping an extra tick if the local clock is too fast. In this implementation it is assumed that the local clock is a simple counter that counts clock ticks. The number of clock ticks between the counter adjusts is determined by the size of adjustment. For example, if a local clock that counts clock ticks as 1 μsec is faster by 10 μsec, and the traceable time value update occurs every 1 second, then every 100 ticks or 100 μsec in this case, one tick has to be skipped by the local clock when counting.

Transmitting Time Request Messages

The time-stamp latch 102 obtains time values from the local clock 101. The packet transmit/receive interface 108 in response to control from the computation engine 106 generates time request messages and transfers them via the communication link 12 to cause the slave node clocks 30-32 to synchronize to the time value, in accordance with the synchronization protocol 100. The time packet recognizer 104 issues commands to the timestamp latch to generate accurate time stamps of when these messages actually leave the master node 16 if required.

Receiving Time Response Messages

The packet transmit/receive interface 108 receives a time response message from the slave node 20-22 and passes the extracted timestamp information from the received response message to the computation engine 106. The time packet recognizer 104 issues commands to the timestamp latch to generate accurate timestamps of when these messages actually arrived at the master node 16 if required. In one embodiment, this timestamp information includes the timestamps (slave node's time domain) of when a slave node received a corresponding time request message and sent the time response message. In some embodiments, the time response message may also include the timestamp (master node's time domain) of the Time Request message sent by the master node; in the corresponding time response message sent by the slave node. The information is passed to the computation engine 106 to determine timing adjustment information to send to the slave node.

Transmitting Sync Time Messages

The computation engine 106 determines timing adjustment information (e.g., the aforementioned clock adjustment interval) using timestamp information from the timestamp latch 102 and/or timestamp (e.g., from slave node's domain) information extracted from received messages by the packet transmit/receive interface 108. The packet transmit/receive interface 108 receives the timing adjustment information (e.g., the clock adjustment interval) from the computation engine 106 and sends it to the slave node via the communication link 12.

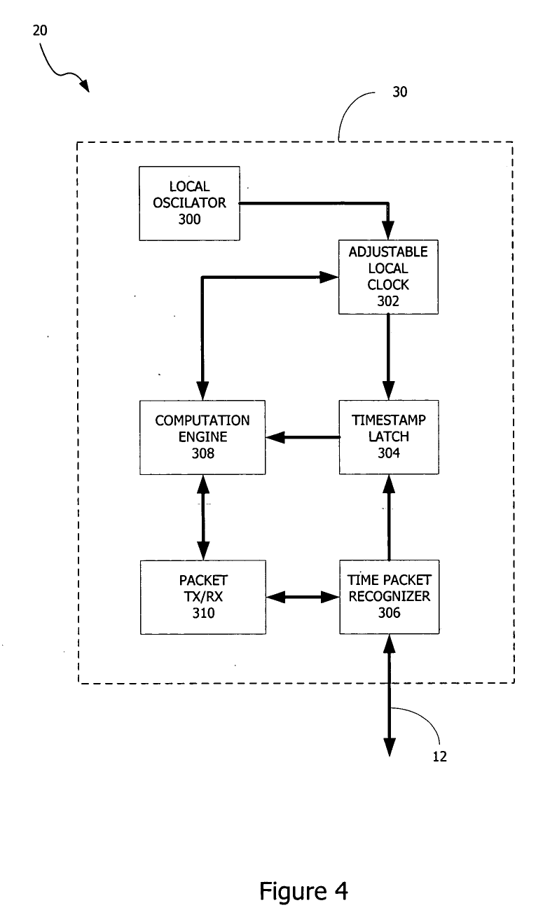

FIG. 4 illustrates an implementation of a slave node (e.g., one of slave nodes 20-22 of FIG. 1), in accordance with an embodiment. In this embodiment, the slave node includes a local oscillator 300, adjustable local clock 302, a timestamp latch 304, a time packet recognizer 306, a computation engine 308 and a packet transmit/receive interface 310. The computation engine 308 does not have to perform the synchronization calculations described above for computation engine 106 of the master node 14. Therefore, the slave node does not need to have the processing capability that the master node 14 has in order to implement the synchronization protocol 100. The computation engine 308 simply loads a register with a value that is used by the local clock counter upon receiving a tick from local oscillator in one implementation or in another implementation a value could indicate after how many local oscillator's ticks to skip one or add one additional clock tick to the local clock counter.

Receiving Time Request Messages

The packet transmit/receive interface 310 receives a time request message from the master node 14 and extracts the timestamp information from the received time request message. The time packet recognizer 306 issues control to the timestamp latch 304 to produce accurate timestamps of when the message actually arrived (in the slave time domain). In one embodiment, this timestamp information includes the timestamps (master node's time domain) of when the master node 14 sent the time request message. The information is passed to the packet transmit/receive interface 310 to include in the time response message (or in a time response message and a follow up message) sent by the slave node to the master node 14 via the communication link 12.

Transmitting Time Response Messages

As described above, the time-stamp latch 304 obtains a time value from the adjustable local clock 302 when the slave node sends a time response message. The timestamp of when the time request message was received is also obtained in some embodiments. The packet transmit/receive interface 310, in response, generates a time response message that includes the timestamps of when the time request message was received, when the time request message was sent by the master node 14, and the timestamp of when the time response message is to be sent. The packet transmit/receive interface 310 then transfers this information to the master node 14 via the communication link 12. In some embodiments, the timestamp of the time response message may be sent in a follow up message and/or the timestamp of when the time request message was sent by the master node 14 may be omitted.

Receiving Sync Time Messages

The packet transmit/receive interface 310 receives the sync time message via the communication link 12. The packet transmit/receive interface 310 obtains the time adjustment information contained in the sync message and passes this information to the computation engine 308. The computation engine 308 uses the timing adjustment information (e.g., the aforementioned clock adjustment interval) to adjust the adjustable local clock 302.

In one embodiment, to adjust the adjustable local clock 302, the computation engine 308 issues the clock adjustment signals to cause the adjustable local clock 302 to either speed up, slow down, maintain rate, or reload with a new time value. In one embodiment, the adjustable local clock 302 is implemented as a counter driven by an oscillator with an adder that adds either value of A, B or C (as described above in conjunction with FIG. 3) to the counter during each period of the local oscillator 300. In one embodiment, this counter configuration is maintained until the next sync message is received from the master node 14.

In another implementation, the computation engine 308 adjusts the local clock 302 by adding an extra tick after some number of clock ticks when the local clock is too slow or by just skipping an extra tick if the local clock is too fast. In this implementation it is assumed that local clock is a simple counter that counts clock ticks. The number of clock ticks when the counter is adjusted is determined by the size of adjustment.

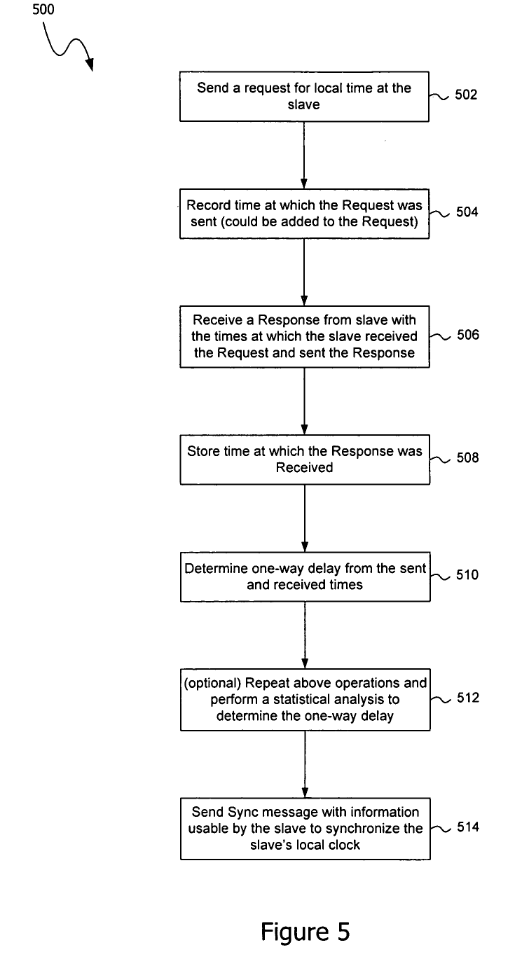

FIG. 5 is a flow diagram representing operational flow 600 of a master in synchronizing a slave, in accordance with an embodiment. The operational flow 600 may be performed in any suitable computing environment. For example, the operational flow 600 may be executed by a computing environment implemented by the master node 14 (FIG. 3).

At an operation 602, a request is sent for the local time at a slave node on a network. In one embodiment, a master node on the network sends the request.

At an operation 604, the time at which request was sent to the slave is recorded. In this embodiment, the master node records the time by including it in the request. In other embodiments, the master locally stores the time.

At an operation 606, a response to the request is received. In one embodiment, the master node receives a response from the slave node and the response includes a timestamp of when the slave sent the response. In this embodiment, the slave node also includes the time the request was sent by the master node (as described above for operation 604). In an alternative embodiment, the timestamp of when the slave node sent the response is sent in a follow-up message sent by the slave node to the master node.

At an operation 608, the time at which the response was received is stored. In this embodiment, the master node stores the time at which the request was received from the slave node.

At an operation 610, the one-way delay is determined. The one-way delay is the time elapsed in sending, for example, a message from the master node to slave node. In one embodiment, the master determines the one-way delay by using equation (1), described above.

At an operation 612, the above operations (602-610) are repeated and the one-way delay is estimated using statistical techniques such as, for example, by determining the mean of the most recent N one way delay cycles; applying a box car filtering algorithm, etc.

At an operation 614, a sync message is sent to the slave containing information that is usable by the slave to synchronize its local clock with that of the master node. In one embodiment, the master node sends the sync message, which includes a time that the slave can simply load into its local clock. In that particular embodiment, the master node calculates the time, accounting for the one-way delay and an estimate of the time needed for the slave to process the sync message and load the time. In other embodiments, the master may include information that is used by the slave node to configure a counter in the local clock that adds or subtracts a configurable number (e.g., 9, 10 or 11) from the current clock value for each cycle of a local oscillator.

Reference has been made throughout this specification to “one embodiment,” “an embodiment,” or “an example embodiment” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that embodiments may be practiced without one or more of the specific details, or with other methods, resources, materials, etc. In other instances, well known structures, resources, or operations have not been shown or described in detail merely to avoid obscuring aspects of the embodiments.

The various embodiments described above are provided by way of illustration only and should not be construed to limit the flowing claims. Those skilled in the art will readily recognized various modifications and changes that may be made in view of the example embodiments and applications illustrated and described herein, and without departing from the true spirit and scope of the following claims.

1. A method of synchronizing a clock of one device with a clock on another device, the method comprising:
(a) sending, by a first device, a request for the local time at a second device;
(b) recording a time at which the request was sent;
(c) receiving a response from the second device, the response including a time at which the second device received the request; (d) storing a time at which the first device received the response; and
(e) determining a one-way delay using the time at which the request was sent by the first device, the time at which the second device received the request, a time at which the second device sent the response, and the time at which the first device received the response.

2. The method of claim 1 wherein the determining is performed by the first device.

3. The method of claim 1 wherein the second device has less processing capability than the first device.

4. The method of claim 1 wherein the response from the second device includes the time at which the response was sent.

5. The method of claim 1 wherein the time at which the response was sent is received in a follow-up message from the second device.

6. The method of claim 1 wherein the one-way delay is determined using the following equation: dT=0.5[(T4−T3)+(T2−T1)], wherein dT is the one-way delay, T4 is the time (in the first device's time domain) at which first device received the response, T3 is the time (second device's time domain) at which the second device sent the response, T2 is the time (second device's time domain) at which the second device received the request, and T1 is the time (first device's time domain) at which the first device sent the request.

7. The method of claim 1 wherein steps (a) through (e) are repeated a predetermined number of times to perform a statistical analysis of the one-way delays.

8. The method of claim 7 wherein the statistical analysis is selected from the group comprising: determining a mean of the determined one-way delays, a boxcar filtering of the determined one-way delays, a truncated Median filtering of the determined one-way delays, a weighted average of the determined one-way delays, and combinations thereof.

9. The method of claim 1 further comprising sending a sync message to the second device, wherein the sync message includes information usable by the second device to synchronize its clock with the clock of the first device.

10. The method of claim 1 further comprising determining by the first device whether a loading threshold is exceeded while synchronizing a plurality of devices, the plurality of devices including the second device, and reducing the loading in response to a determination that the loading threshold was exceeded.

11. The method of claim 10 wherein the loading is determined using one or more of:
a number of devices to be synchronized by the first device;
an amount available unused memory on the first device;
a measurement of processing capability usage on the first device; and
an amount of traffic on a communication link used by the first device and the plurality of devices.

12. The method of claim 10 further comprising determining by the first device whether a loading threshold would be exceeded by adding another device to the plurality of devices, and not adding the device in response to a determination that the threshold would be exceeded.

13. A synchronization system for use in a first device, the system comprising:
a clock;
a timestamp latch coupled to the clock;
a time packet recognizer coupled to the timestamp latch;
a packet interface coupled to the time packet recognizer; and
a computation engine coupled to the timestamp latch, the clock, and the packet interface, wherein the computation is to sending a request for the local time at a second device, record a time at which the request was sent, receive from the second device a response including a time at which the second device received the request, store a time at which the first device received the response, and determine a one-way delay using the time at which the request was sent by the first device, the time at which the second device received the request, a time at which the second device sent the response, and the time at which the first device received the response.

14. The system of claim 13 wherein the second device has less processing capability than the first device.

15. The system of claim 13 wherein the response from the second device includes the time at which the response was sent.

16. The system of claim 13 wherein the time at which the response was sent is received in a follow-up message from the second device.

17. The system of claim 13 wherein the one-way delay is determined using the following equation: dT=0.5[(T4−T3)+(T2−T1)], wherein dT is the one-way delay, T4 is the time (in the first device's time domain) at which first device received the response, T3 is the time (second device's time domain) at which the second device sent the response, T2 is the time (second device's time domain) at which the second device received the request, and T1 is the time (first device's time domain) at which the first device sent the request.

18. The system of claim 13 wherein the one-way delay is determined a predetermined number of times and a statistical analysis of the determined one-way delays.

19. The system of claim 18 wherein the statistical analysis is selected from the group comprising determining a mean of the determined one-way delays, a boxcar filtering of the determined one-way delays, a truncated median filtering of the determined one-way delays, and a weighted average of the determined one-way delays.

20. The system of claim 13 wherein the computation engine is further to send a sync message to the second device, wherein the sync message includes information usable by the second device to synchronize its clock with the clock of the first device.

21. The system of claim 13 wherein the first device is to determine whether a loading threshold is exceeded while synchronizing a plurality of devices, the plurality of devices including the second device, and wherein the first device is to reduce the loading in response to a determination that the loading threshold was exceeded.

22. The system of claim 21 wherein the loading is determined using one or more of:
a number of devices to be synchronized by the first device;
an amount available unused memory on the first device;
a measurement of processing capability usage on the first device; and
an amount of traffic on a communication link used by the first device and the plurality of devices.

23. The system of claim 21 further comprising determining by the first device whether a loading threshold would be exceeded by adding another device to the plurality of device, and not adding the device in response to a determination that the threshold would be exceeded.

24. An apparatus for synchronizing a clock of one device with a clock on another device, the apparatus comprising:
means for sending, by a first device, a request for the local time at a second device;
means for recording a time at which the request was sent;
means for receiving a response from the second device, the response including a time at which the second device received the request;
means for receiving a time at which the response was sent;
means for storing a time at which the first device received the response; and
means for determining a one-way delay using the time at which the request was sent by the first device, the time at which the second device received the request, the time at which the second device sent the response, and the time at which the first device received the response.

25. The apparatus of claim 24 wherein the second device has less processing capability than the first device.

26. The apparatus of claim 24 wherein the response from the second device includes the time at which the response was sent.

27. The apparatus of claim 24 wherein the one-way delay is determined using the following equation: dT=0.5[(T4−T3)+(T2−T1)], wherein dT is the one-way delay, T4 is the time (in the first device's time domain) at which first device received the response, T3 is the time (second device's time domain) at which the second device sent the response, T2 is the time (second device's time domain) at which the second device received the request, and T1 is the time (first device's time domain) at which the first device sent the request.
